(19) United States
(12) Patent Application Publication
(10) Pub. No.: US 2013/0305063 A1
(43) Pub. Date: Nov. 14, 2013

(54) UPS DEVICE AND UPS STRUCTURE WITH PROLONGED POWER SUPPLY

(71) Applicants: Tsun-Te SHIH, New Taipei City (TW); Yu-Yuan Chang, New Taipei City (TW); Kuang-Lung Shih, New Taipei City (TW); Po-Wen Hsiao, New Taipei City (TW)

(72) Inventors: Tsun-Te SHIH, New Taipei City (TW); Yu-Yuan Chang, New Taipei City (TW); Kuang-Lung Shih, New Taipei City (TW); Po-Wen Hsiao, New Taipei City (TW)

(21) Appl. No.: 13/467,688

(22) Filed: May 9, 2012

(51) Int. Cl. G06F 1/26

(52) U.S. Cl. 713/300

(57) ABSTRACT

An uninterruptible power supply (UPS) device for providing a DC operating power to operate a motherboard is disclosed. The UPS device includes a main power supply system, a backup power supply system and a disable control unit. In a normal condition, the main power supply system converts and outputs a first DC standby power to the motherboard. The backup power supply system outputs a second DC standby power to the motherboard when the main power supply system is incapable of normally outputting the first DC standby power. The disable control unit receives a power supply-off signal outputted by the motherboard in a power-off state to generate a disable signal to the backup power supply system. In response to the disable signal, the backup power supply system stops outputting the second DC standby power to the motherboard.

### FIELD OF THE INVENTION

The present invention relates to an uninterruptible power supply (UPS) structure, and particularly to a UPS structure with prolonged power supply.

### BACKGROUND OF THE INVENTION

All types of electronic apparatuses require a stable operating power. Therefore, a power supply is needed to for powering the electronic apparatuses. Most common power supplies are connected to an input source to obtain an input power, which is converted through a power conversion unit of the power supply into a driving power further transmitted to a load. However, such conventional structure comprises only one input source for providing an input power, with the input source possibly being city electricity or another power supply. In the event of a power failure or a malfunction of the city electricity or the power supply, a corresponding electric apparatus is powered off and shut down or even a power supply driving the electronic apparatus is damaged from an overload in a boost unit. To prevent issues resulted from a single malfunctioning input source, an uninterrupted power supply (UPS) connected to the power supply is provided in the prior art. In response to a malfunctioning input source, by providing temporary but stable electricity for driving the electronic apparatus, the UPS system is capable of reducing a risk of unexpectedly losing an input power.

Common power standards for a power supply in a computer system are such as Advanced Technology eXpanding (ATX) including ATX2.0, ATX2.1 and AT2.2 versions. Based on 110 Vac/220 Vac city electricity received by a power supply of an ATX structure, a power output port of the ATX structure is capable of outputting a DC operating power of +3.3V, +5V and +12V as well as a standing power of +5 VSB whether the ATX structure is powered on or off. The standing power is mainly for prompting other systems (e.g., a main power supply system, a protection system and a control chip) to enter a standby state, and a main power supply system only starts to convert the city electricity to a main output power for powering various devices in the computer when the power supply is activated (a same activation signal for activating the computer usually first activates the power supply). Further, a power supply of an ATX system is capable of implementing a remote on/off function.

Although an ATX structure offers the advantages above, the ATX structure nevertheless faces a concern of being required to constantly provide the +5 VSB standing power. A power supply with a UPS under a normal power supply condition, a main power supply system converts an AC power of city electricity to provide a DC power of +3.3V, +5V and +12V as well as a standing power of +5 VSB. Therefore, given that the main power supply system stays electrically connected with city electricity, the main power supply system is capable of providing sufficient power for powering a rear-end electronic apparatus. However, when the main power supply system is damaged or malfunctions, the power needed by the electronic apparatuses are provided by the UPS instead of the main power supply system. It should be noted that the UPS is generally an energy storage device that provides a limited amount of power for emergency uses. In addition, since the +5 VSB standing power is constantly outputted, the power in the UPS is persistently lost even when the electronic apparatuses are powered off. As a result, the service duration that the UPS substitutes the main power supply system is significantly shortened. Further, it is possible that the electric apparatuses be unexpectedly disconnected due to power depletion when the electronic apparatuses are being powered off or when data is being stored to the electronic apparatuses, such that greater damages of the electronic apparatuses may be incurred.

### SUMMARY OF THE INVENTION

Therefore the primary object of the present invention is to prolong a power supply duration of an uninterruptible power supply (UPS).

To achieve the foregoing object, the disclosure provides a UPS device with prolonged power supply. The UPS provides a DC operating power for powering a motherboard for normal operations. The motherboard has a power-off state, which generates a power supply-off signal to the US device to stop outputting the DC operating power. The UPS device comprises a main power supply system, a backup power supply system and a disable control unit. The main power supply system is electrically connected to an external power source, and converts and outputs a first DC standby power to the motherboard in a normal condition. When the main power supply system is incapable of normally outputting the first DC standby power, the backup power supply system outputs a second DC standby power to the motherboard. The disable control unit, electrically connected to the motherboard and the backup power supply system, receives the power supply-off signal outputted by the motherboard in a power-off state to generate a disable signal corresponding to the power supply-off signal to the backup power supply system. In response to the disable signal, the backup power supply system stops outputting the second DC standby power to the motherboard.

In one embodiment, the motherboard has a power-on state, in which the motherboard generates a power activation signal to the UPS device to output the DC operating power.

In one embodiment, the backup power supply system comprises at least one energy storage module for storing the second DC standby power.

In one embodiment, the DC operating power comprises a first DC operating power converted and outputted by a main power supply system and a second DC operating power outputted by the backup power supply system.

In one embodiment, the backup power supply system is electrically connected to the main power supply system, and comprises at least one energy storage module for storing the second DC operating power.

In one embodiment, the energy storage unit is a rechargeable battery.

In one embodiment, the backup power supply system comprises charging unit. The charging unit obtains the first DC operating power and charges the first DC operating power into the energy storage unit.

In one embodiment, the UPS device further comprises a voltage modulation unit. The voltage modulation unit is disposed between the main power supply system and the motherboard, and modulates a voltage of the first DC standby power.

In one embodiment, the UPS device further comprises a voltage modulation unit. The voltage modulation unit is disposed between the main power supply system and the motherboard, and modulates a voltage of the second DC standby power.

In one embodiment, the disable control unit further comprises a control switch.

In one embodiment, the main power supply system comprises a rectifier and filter unit connected to the external power source, a power factor correction unit connected to the rectifier and filter unit, a transformer, a pulse width control unit, a switch unit and a rectification output unit.

The disclosure further provides a UPS structure with prolong power supply. The UPS structure comprises a main power supply system, a backup power supply system, a motherboard electrically connected to the main power supply system and the backup power supply system, and a disable control unit. The main power supply system is electrically connected to an external power source, and converts and outputs a first DC operating power in a normal condition and constantly converts and outputs a first DC standby power. The backup power supply system outputs a second DC operating power and a second DC standby power when the main power supply system is incapable of normally outputting the first DC standby power. The motherboard generates a power supply-off signal in a power-off state to the main power supply system to stop outputting the first DC operating power. The disable control unit, electrically connected to the motherboard and the backup power supply system, receives the power supply-off signal outputted by the motherboard in the power-off state to generate a disable signal corresponding to the power supply-off signal. In response to the disable signal, the backup power supply system stops outputting the second DC standby power to the motherboard.

Therefore, the UPS device and the UPS structure of the present invention are capable of effectively saving the DC standby power that is persistently consumed when an electronic apparatus is powered off, so that the DC standby power in the backup power supply system can be utilized for emergencies to prolong a service duration of the DC standby power.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is schematic diagram of a power supply structure of a UPS device with prolonged power supply according to one embodiment of the present invention.

FIG. 2 is a schematic diagram of a UPS structure with prolonged power supply according to one embodiment of the present invention.

### DETAILED DESCRIPTION OF THE PREFERRED EMBODIMENTS

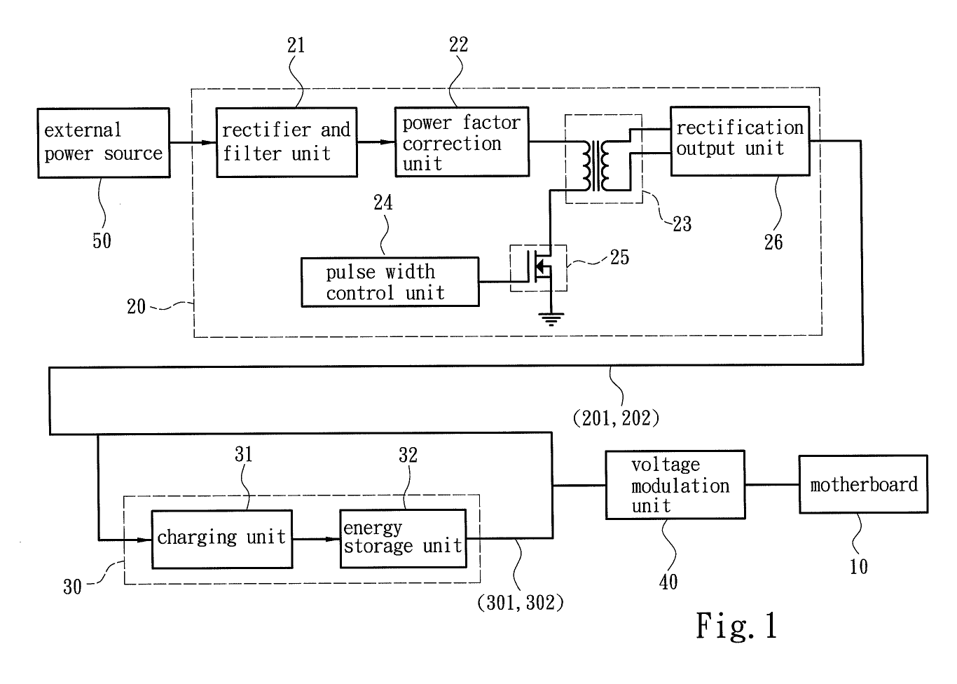

FIG. 1 shows a schematic diagram according to one embodiment of the present invention. The power system in FIG. 1 is a UPS device with prolonged power supply applied in a computer system. The UPS device comprises a motherboard 10, a main power supply system 20 and a backup power supply system 30. The main power supply system 20 and the backup power supply system 30 are connected to the motherboard 10. The motherboard 10 at least comprises a central processing unit (CPU) and other electronic units as well as circuit layouts. The main power supply system 10 outputs power to the motherboard 10 in a normal condition, and the backup power supply system 30 serves as a substitute of the main power supply system 20 to provide power to the motherboard 10 in the event that the main power supply system 20 is incapable of normally outputting power.

In this embodiment, the main power supply system 20 and the backup power supply system 30 may be integrated into a UPS power supply. The main power supply system 20 comprises a rectifier and filter unit 21 connected to an external power source 50, a power factor correction unit 22 connected to the rectifier and filter unit 21, a transformer 23, a pulse width control unit 24, a switch unit 25 and a rectification output unit 26. After an external AC power outputted by the external power source 50 passes through the rectifier and filter unit 21 and the power factor correction unit 22, a power factor and a voltage of the external power are adjusted by a transformer power level in the power factor correction unit 22. The pulse width control unit 24 determines a work period of the switch unit 25 to adjust a coil current passing through the transformer 23. The rectification output unit 26 then generates a DC power and transmits the DC power to the motherboard 10. In one embodiment of the present invention, the DC power outputted by the main power supply system 20 in a normal condition includes a first DC operating power 201 and a constantly outputted first DC standby power 202. For example, the first DC operating power 201 includes +3.3V, +5V and +12V power, and the first DC standby power 202 is a +5 VSB power.

The backup power supply system 30 comprises a charging unit 31 and at least one energy storage module 32. The charging unit 31 obtains the first DC operating power 201 converted and outputted by the main power supply system 20. The energy storage module 32 receives the first DC operating power 201 inputted by the charging unit 31 and stores the first DC operating power 201 as a backup power. The backup power includes a second DC operating power 301 and a constantly outputted second DC standby power 302. For example, the second DC operating power 301 includes +3.3V, +5V and +12V power, and the second DC standby power 302 is a +5 VSB power. In this embodiment, the energy storage module 32 is a rechargeable battery.

According to one embodiment of the present invention, the main power supply system 20 and the backup power supply system 30 are capable of directly outputting the first DC standby power 202 and the second DC standby power 302 to the motherboard 10. In an alternative embodiment, a rear end of the main power supply system 20 and the backup power supply system 30 is electrically connected to a voltage modulation unit 40. The voltage modulation unit 40 receives the first DC standby power 202 and the second DC standby power 302, and modulates the output voltages of the first DC standby power 202 and the second DC standby power 302 according to a corresponding voltage value required by the motherboard 10.

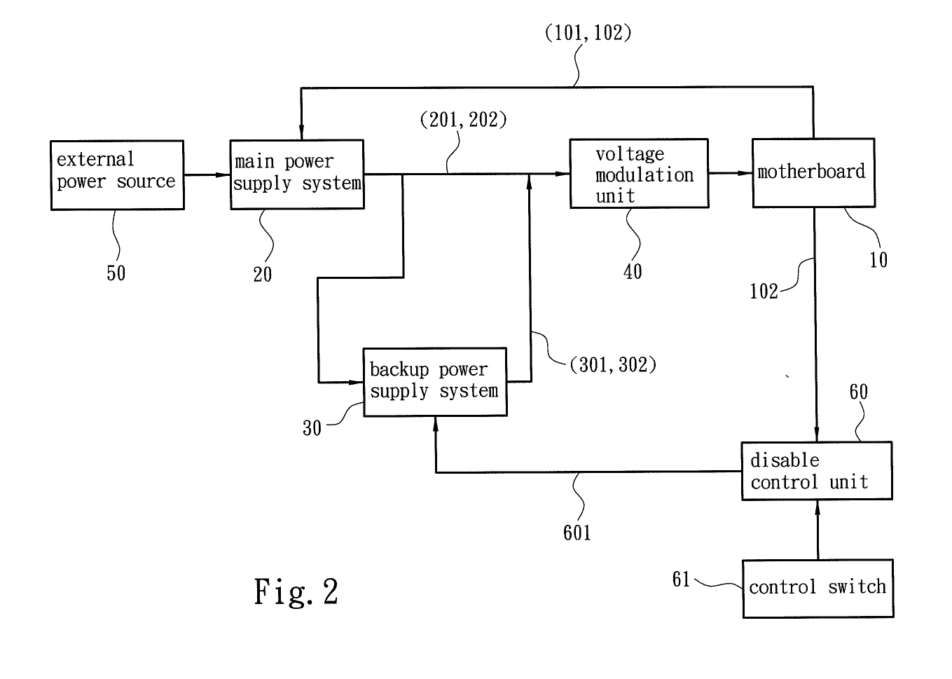

FIG. 2 shows a schematic diagram according to one embodiment of the present invention. The motherboard 10 obtains the first DC operating power 201 and the first DC standby power 202 outputted by the main power supply system 20 in a normal condition. When the main power supply system 21 is incapable of normally outputting the first DC operating power 201 and the first DC standby power 202, the backup power supply system 30 provides the second DC operating power 301 and the second DC standby power 302 instead. The motherboard 10 has a power-on state and a power-off state. In the power-on state, the motherboard 10 generates a power activation signal 101 to the main power supply system 20 to output the first DC operating power 201. In the power-off state, the motherboard 10 generates a power supply-off signal 102 to the main power supply system 20 to stop outputting the first DC operating power 201.

According to one embodiment of the present invention, the motherboard 10 is electrically connected to a disable control unit 60. The disable control unit 60 receives the power supply-off signal 102 outputted by the motherboard 10 in the power-off state to generate a disable signal 601 corresponding to the power supply-off signal 102 to the backup power supply system 40. In response to the disable signal 601 received, the backup power supply system 30 becomes completely powered off, and stops outputting the second DC standby power 302 to the motherboard 10. The disable control unit 60 comprises a control switch 61. The control switch 61 controls the disable control unit 60 to output the disable signal 601 according to the power supply-off signal 102 from the motherboard 10, or controls the disable control unit 60 to constantly output the disable signal 601 to completely power off the backup power supply system 30.

In a normal power supply condition of the main power supply system 20, the main power supply system 20 outputs the first DC operating power 201 and the first DC standby power 203 to the motherboard 10 when the computer system is in the power-on state. When the computer system is in the power-off state, the motherboard 10 outputs the power supply-off signal 102 to the main power supply system 20. In an ATX structure, the main power supply system 20 only provides the first DC standby power 202.

Once the main power supply system 20 fails to normally provide power, the backup power supply system 30 provides backup power instead. Thus, when the computer is in the power-on state, the backup power supply system 30 outputs the second DC operating power 301 and the second DC standby power 302 to the motherboard 10. When the computer system is in the power-off state, the motherboard 10 outputs the power supply-off signal 102 to the disable control unit 60. In response to the power supply-off signal 102, the disable control unit 60 generates the corresponding disable signal 601 to the backup power supply system 30. In response to the disable signal 601, the backup power supply system 30 becomes completely powered off and stops outputting the second DC operating power 301 and the second DC standby power 302 to the motherboard 10.

In a conventional UPS, due to the constantly outputted +5 VSB standby power required by an ATX structure, the power in a backup battery is persistently released although a computer system may already enter a power-off state, resulting in a shortened service duration of the backup power. In the UPS device with prolonged power supply according to one embodiment of the present invention, the disable control unit is provided between the mother board and the backup power supply system. When the main power supply is incapable of normally providing power and power is provided by the backup power supply system instead, as the computer system enters the power-off state, apart from disconnecting the second DC operating power of the backup power supply system, the second DC operating power and the second DC standby power of the backup power supply system are also disconnected from the motherboard. Accordingly, the power stored in the backup power supply system is effectively saved to prolong the service duration of the backup power for emergency uses.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An uninterruptible power supply (UPS) device with prolonged power supply, for providing a DC operating power for a normal operation of a motherboard of an electronic apparatus, the motherboard including a power-off state, in which the motherboard generating a power supply-off signal to the UPS device to stop outputting the DC operating power, the UPS device comprising:
a main power supply system, electrically connected to an external power source, for converting and outputting a first DC standby power to the motherboard in a normal condition;
a backup power supply system, for outputting a second DC standby power to the motherboard when the main power supply system is incapable of normally outputting the first DC standby power; and
a disable control unit, electrically connected to the motherboard and the backup power supply system, for receiving the power supply-off signal outputted by the motherboard in the power-off state to generate a disable signal corresponding to the power supply-off signal to the backup power supply system;
wherein, in response to the disable signal, the backup power supply system stops outputting the second DC standby power to the motherboard.

2. The UPS device of claim 1, wherein the motherboard includes a power-on state, in which the motherboard generates a power activation signal to the UPS device to output the DC operating power.

3. The UPS device of claim 1, wherein the backup power supply system comprises at least one energy storage module for storing the second DC standby power.

4. The UPS device of claim 3, wherein the energy storage module is a rechargeable battery.

5. The UPS device of claim 1, wherein the DC operating power comprises a first DC operating power converted and outputted by the main power supply system and a second DC operating power outputted by the backup power supply system.

6. The UPS device of claim 5, wherein the backup power supply system is electrically connected to the main power supply system, and comprises at least one energy storage module for storing the second DC operating power.

7. The UPS device of claim 6, wherein the backup power supply system further comprises a charging unit, which obtains the first DC operating power and charges the first DC operating power into the energy storage module.

8. The UPS device of claim 6, wherein the energy storage module is a rechargeable battery.

9. The UPS device of claim 1, further comprising a voltage modulation unit disposed between the main power supply system and the motherboard, for modulating a voltage of the first DC standby power.

10. The UPS device of claim 1, further comprising a voltage modulation unit disposed between the backup power supply system and the motherboard, for modulating a voltage of the second DC standby power.

11. The UPS device of claim 1, wherein the disable control unit comprises a control switch.

12. The UPS device of claim 1, wherein the main power supply system comprises a rectifier and filter unit connected to the external power source, a power factor correction unit connected to the rectifier and filter unit, a transformer, a pulse width control unit, a switch unit and a rectification output unit.

13. A UPS structure with prolonged power supply, comprising:
a main power supply system, electrically connected to an external power source, for converting and outputting a first DC operating power and constantly converting and outputting a first DC standby power in a normal condition;
a backup power supply system, for outputting a second DC operating power and a second DC standby power when the main power supply system is incapable of normally outputting the first DC standby power; and
a motherboard, respectively electrically connected to the main power supply system and the backup power supply system to obtain the first DC standby power or the second DC standby power, the motherboard generating a power supply-off signal in a power-off state to the main power supply system or the backup power supply system to stop outputting the first DC operating power or the second DC operating power; and
a disable control unit, electrically connected to the motherboard and the backup power supply system, for receiving the power supply-off signal outputted by the motherboard in the power-off state to generate a disable signal corresponding to the power supply-off signal;
wherein, in response to the disable signal, the backup power supply system stops outputting the second DC standby power to the motherboard.

14. The UPS structure of claim 13, wherein the motherboard includes a power-on state, in which the motherboard generates a power activation signal to the main power supply system to output the first DC operating power.

15. The UPS structure of claim 13, wherein the backup power supply system comprises at least one energy storage module for storing the second DC standby power.

16. The UPS structure of claim 13, wherein the backup power supply system is electrically connected to the main power supply system, and comprises at least one energy storage module for storing the second DC operating power.

17. The UPS structure of claim 16, wherein the backup power supply system further comprises a charging unit, which obtains the first DC operating power and charges the first DC operating power into the energy storage module.

18. The UPS structure of claim 13, further comprising a voltage modulation unit disposed between the backup power supply system and the motherboard, for modulating a voltage of the first DC standby power.

19. The UPS structure of claim 13, further comprising a voltage modulation unit disposed between the backup power supply system and the motherboard, for modulating a voltage of the second DC standby power.

20. The UPS structure of claim 13, wherein the disable control unit comprises a control switch.
